(19) United States
(12) Patent Application Publication
(10) Pub. No.: US 2006/0014005 A1
(43) Pub. Date: Jan. 19, 2006

(54) Method for realizing a sensor device able to detect chemical substances and sensor device so obtained

(75) Inventors: Andrea Basco, Napoli (IT); Maria Viviana Volpe, Pozzuoli (IT); Valeria Casuscelli, Napoli (IT); Salvatore Coffa, Tremestieri Etneo (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 11/152,672

(22) Filed: Jun. 14, 2005

(30) Foreign Application Priority Data
Jun. 30, 2004 (EP) 0442548836

(51) Int. Cl. B05D 5/12

(52) U.S. Cl. 428/209; 427/58; 427/180

(57) ABSTRACT

A method realizes a sensor device suitable for detecting the presence of chemical substances and comprises, as detection element, an active film of metallic nanoparticles able to interact with the chemical substances to determine a variation of the global electric conductivity of the film. The method includes preparing an ink comprising a solution of metallic nanoparticles, and depositing the obtained ink on a supporting substrate by ink-jet printing so as to form the active film.

### BACKGROUND OF THE INVENTION

1. Field of the Invention

The present invention relates, in its more general aspect, to a method for monitoring the presence of chemical substances, also called analytes, in a determined environment.

In particular, the present invention relates to a method for realizing a sensor device, of the type comprising, as detection element, an active film of metallic nanoparticles sensitive to the presence of the above chemical substances.

The present invention also relates to a sensor device obtained with the above method.

2. Description of the Related Art

In the field the need of realizing sensor devices able to detect the presence of one or more chemical substances in a determined environment is known, mainly of gaseous environmental pollutants, both of organic nature, such as polychlordibenz-dioxins, polychloro-biphenyls, aromatic compounds and condensate rings in general, and of inorganic nature, such as nitrogen and sulphur oxides.

The age-old problem of monitoring in an accurate way the organic compounds of the dioxin family, produced in the incinerators by the combustion of chlorinated plastic materials is particularly known.

In particular, there is a need for very sensitive sensor devices that are able to detect minimal amounts, of the order of the ppb, of these substances.

So as to satisfy this need, the interest is deeper and deeper in a technique for monitoring chemical substances by employing nanostructured materials. This interest has is due to the electronic transport properties of these materials.

Nanostructured materials substantially comprise a plurality of highly organized metallic nanoparticles, also called metallic nanoclusters. The word metallic nanoparticle means a particle having dimensions generally comprised between 0.1 and 100 nm, preferably in the order of 1-10 nm, and having a metallic nucleus, for example gold, platinum or palladium, which is covered by means of a shell for being stabilized.

The cover is obtained by means of capping agents, which usually comprise polymers able to maintain the metallic nuclei separated, or by means of passivating agents, which usually comprise organic compounds with reactive groups, such as thiols and amines.

Recent developments have shown the possibility of realizing sensor devices wherein the active matrix comprises a film of gold nanoparticles of the above specified type which are deposited on insulating layers, as described for example in the articles of A. W. Snow, H. Wohltjen and N. L. Jarvis: “MIME Chemical Vapor Microsensor”, 2002, NRL Review, and N. L. Jarvis, A. W. Snow, H. Wohltjen and R. R. Smardzewski: “CB Nanosensors”.

The developed technology is based on a morphologic alteration of the nanoparticle film which results in a variation of the conductivity thereof.

This technology is described for example in the U.S. Pat. No. 6,221,673. This document discloses the realization of a sensor device comprising a detection cell having an active matrix of packed nanoparticles. Each particle comprises a conductive metallic nucleus and a passivating shell.

The detection of the analytes is obtained by means of interaction of the passivating shell with the analyte so as to determine the alteration of the overall conductive property of the film of metallic nanoparticles.

In substance, the analyte, by interacting with the passivating shell, causes an increase of the distance between the metallic nanoparticles and, as a consequence, a decrease of the probability of electronic tunneling phenomena or electronic hopping, which are responsible for the conduction.

For realizing the detection cell, the known method comprises the preparation of an inert support, suitably provided with electrodes necessary for measuring the conductivity variation and generally realized by means of expensive techniques such as the traditional photolithography. In a second step a solution of the above describe nanoparticles is deposited, in suitable solvents, to form a film covering the electrodes.

The deposition of the film alternatively occurs according to two techniques.

A first technique provides to spray the solution of nebulized nanoparticles on the surface of the substrate, preferably pre-heated at a temperature higher than the boiling point of the solvents.

A second technique provides to initially apply, on the substrate surface, a solution of coupling agents, which are two-function substances, comprising a first functional group able to bind with the substrate and a second functional group able to bind with the nanoparticles. Afterwards, the substrate is dipped in the solution of nanoparticles so as to allow the bond with the solution and to obtain the desired film. This known method, although allowing an accurate analytes detection, has however known drawbacks still unsolved.

The main drawbacks of the known techniques for realizing the electrodes (lithography) are that they are very expensive, and that the deposition of nanoparticle solutions has such reproducibility problems as to prevent the realization of sensor devices on a large scale.

This drawback is even more evident if the need, in the environment monitoring field, of providing a high number of sensor devices is considered, having comparable and constant qualities in terms of sensitiveness and specificity of detection of determined polluting substances.

### BRIEF SUMMARY OF THE INVENTION

One embodiment of the present invention is a method for the realization of the above-specified sensor device of chemical substances, which ensures a high process reproducibility and reliability, which has a reduced cost and which offers a drastic reduction of the number of steps necessary for the realization of the sensor device.

The method includes:
preparing an ink comprising a solution of metallic nanoparticles, and
jet printing the thus obtained ink so as to form an active film of metallic nanoparticles.

The detection mechanism of the active film is related to the variation of electric conductivity occurring as effect of the interaction between the metallic nanoparticles of the film and the chemical substances to be detected.

Further characteristics and advantages of the method and of the sensor according to the invention will be apparent from the following description of an embodiment thereof given by way of indicative and non limiting example with reference to the annexed drawings.

### BRIEF DESCRIPTION OF THE SEVERAL VIEWS OF THE DRAWINGS

In the drawings:

FIG. 1 shows a block scheme of the method according to one embodiment of the present invention;

FIG. 2 shows a schematic view of the sensor device according to one embodiment of the present invention;

FIG. 3 shows a schematic view of an ink-jet printing step;

FIG. 4 shows a schematic view of interdigitated electrodes realized according to the method of FIG. 1.

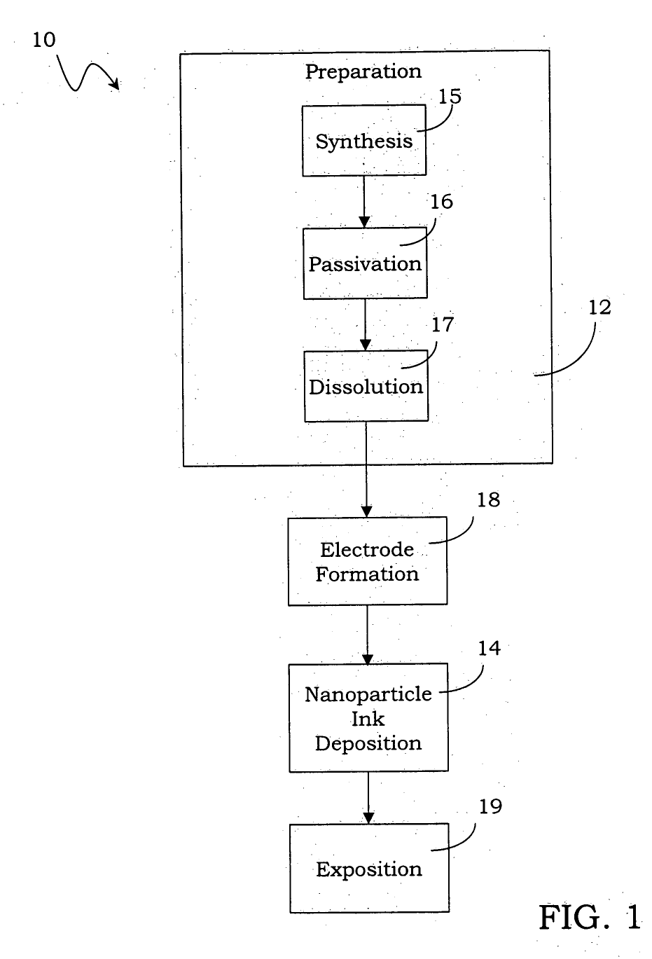

### DETAILED DESCRIPTION OF THE INVENTION

With reference to the annexed drawings, reference number 10 globally indicates a scheme of a method according to the invention for the realization of a sensor device suitable for monitoring chemical substances.

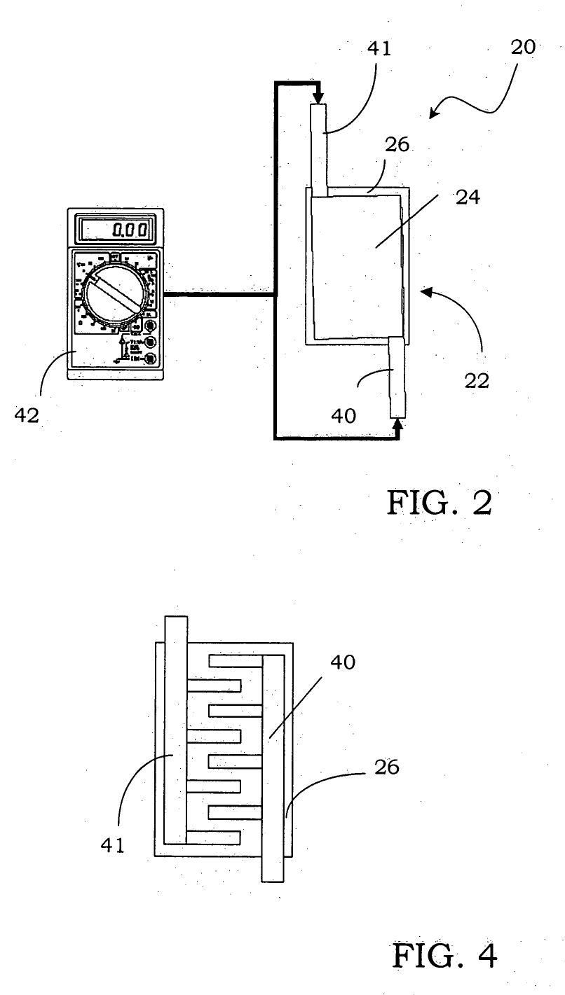

The method 10 is used in the specific case for realizing a sensor device 20 of polluting gases, shown in FIG. 2, of the type comprising a detection cell 22 having an active film 24 of metallic nanoparticles formed on a supporting substrate 26. The nanoparticles are able to interact with the polluting gases to determine a variation of the global electric conductivity of the film 24.

In the specific case, gold is the metal of the nanoparticles, and the nanoparticles have a mean dimension of 5 nm.

The method 10 comprises as main steps:
a preparation step 12 of an ink comprising a solution of metallic nanoparticles, and a deposition step 14 of the ink obtained on the supporting substrate 26 by means of ink-jet printing so as to form the active film 24.

The method also includes an electrode formation step 18 for forming electrodes as discussed below with respect to FIG. 2 and an exposition step 19 in which the sensor device 20 is exposed to a controlled atmosphere enriched with a chemical substance to characterize the electric response to a known concentration of the substance.

The preparation step 12 of the ink preferably comprises a synthesis step 15 of synthesizing metallic nuclei, a passivation step 16 of passivating the metallic nuclei to obtain metallic nanoparticles, and a dissolution step 17 dissolving the nanoparticles in solvent to obtain the ink.

The synthesis 15 of the metallic nuclei is carried out according to consolidated synthesis techniques.

A first synthesis technique, so called by means of polyol process, is based on the oxidation-reduction reaction which occurs between a metallic precursor, in the specific case a gold precursor, and an alcholic reducing agent, which also plays the role of reaction solvent.

In the reaction environment a capping agent is also used for controlling the morphology and the dimensions of the metallic nanoclusters. As capping agent also a polymer can be used being soluble in the solvent and having a extension and a molecular weight suitable for the control of the metallic nucleus growth.

The most accredited reaction mechanism for the reduction of the metal (Meⁿ⁺) to elemental metal (Me), in this case from Au³⁺ to Au, is the following.
CH₂OH—CH₂OH→CH₃CHO+H₂O
2 CH₃CHO→CH₃CO—CO—CH₃+H₂
nH₂+2Meⁿ⁺→2Me+2nH+
mMe+PVP→Meₘ-PVP→Meₘ₊₁-PVP

In a preferred solution, trihydrated chloride of Au(III) is used (HAuCl₄H₂O) as metallic precursor, ethylene glycol (EG) as reducing agent and polyvinylpyrrolidone (PVP) as capping agent. An example of this synthesis is described as example in the article “P.-Y. Silvert, K. Tekaya-Elhsissen, Solid State Ionics, 1995, vol 82, pg. 53-60” and in “Volpe M. V., Longo A., Pasquini L., Casuscelli V., Carotenuto G., J. Mater. Science Letters 2003, vol. 22, pg. 1697-1699”.

An example of synthesis by a Polyole Process is reported at the end of the present description.

Afterwards the metallic nuclei are subjected to the above passivation step 16 to obtain metallic nanoparticles.

The passivation is preferably carried out by adding an organic compound having a reactive group, such as a thiol (R—SH) or an amine, to the solution of the PVP-stabilized metallic nuclei, which are previously obtained.

The type of passivating agent is not considered as limitative for the present invention, and any known passivating agent can be used, such as aliphatic thiols, straight- or branched-chained, substituted aliphatic thiols, aromatic thiols and the like.

Also dendrimer compounds can be used as passivating agents such as those described in “Nadeja Krasteva, Isabelle Besnard, Berit Guse, Roland E. Bauer, Klaus Mullen, Akio Yasuda, and Tobias Vossmeyer, Nano Letters 2002 Vol. 2, No. 5 pg. 551-555” and “Nadeja Krasteva, Berit Guse, Isabelle Besnard, Akio Yasuda and Tobias Vossmeyer, Sensors and Actuators B 92 (2003) 137-143”.

The passivation mechanism is the following:
Meₙ—PVP+mR—SH→Meₙ(SR)ₘ+m/2H₂+PVP.

The obtained metallic nanoparticles have dimensions comprised between 4.5 and 10 nm and they are easily separated, by centrifugation, from the excess of thiol and of polymer, with obtainment of a stable, solid product.

Afterwards, the nanoparticles are dissolved in the above dissolution step 17 in a suitable solvent with obtainment of the ink. The choice of the solvent depends, as it will be seen more clearly hereafter, on the operative conditions of the ink-jet printing. Preferably, the used solvent is organic, such as for example toluene, chloroform, hexane and superior homologs and the like.

In the specific case, the obtained ink comprises a colloidal solution in toluene of gold nanoparticles.

According to a further embodiment, the method according to the invention comprises a synthesis step of the metallic nanoparticles by means of a so called two-phase system. This technique provides the use of a ionic metallic precursor, of a phase transfer agent and of a reducing agent. This synthesis technique is known for example from “Brust M., Walker M., Bethell D., Shiffrin D. J. And Whyman R., J. Chem. Soc., Chem. Commun., 1994, pg. 801-802”.

The strategy of this synthesis mechanism is that of making the metallic nanocluster grow so that a simultaneous fixing of self-assembled passivating agent monolayers occurs on the growing metallic nucleus.

To this purpose, the nanoparticles are grown in a two-phase system, and in particular two-phase oxidation-reduction reactions are carried out by using suitable oxidation-reduction reactants in each adjacent step.

The difference with respect to the previous synthesis is that the passivating step is simultaneous and competitive with the nanoparticle growth. Moreover, the procedure is of the “one pot” type since the two processes occur in the same reaction means.

In particular, in the specific case, HAuCl₄ is used as metallic precursor, an emulsion of H₂O, toluene and passivating agent (for example dodecanthiol) as two-phase reaction means, tetraoctylammonium bromide ((C₈H₁₇)₄NBr or N(Oct)₄Br) as phase transfer agent, and aqueous sodium borohydride (NaBH₄) as reducing agent. The phase transfer agent allows the transfer of the metallic precursor from water to toluene.

In detail, the synthesis/passivation step is set out in the following stages.

Initially the metallic ionic precursor is dissolved in water in the presence of N(Oct)₄Br. Afterwards, the organic phase, constituted by the passivating agent in toluene, is added to the aqueous solution.

The addition is carried out under vigorous agitation so as to obtain an emulsion and to allow the transfer of Au(III) in toluene.

Afterwards, the reducing agent is added to the emulsion, which reduces the gold in the presence of the passivating agent.

The mechanism of the nucleation and growth of the metallic nanoparticles is the following:
4Meⁿ⁺+nBH₄⁻+3nH₂O→4Me+nH₂BO₃⁻+4nH⁺+2nH₂

The passivation mechanism is:
Meₘ+n(R—SH)→Meₘ(S—R)ₙ

An example of synthesis by means of two-phase system is reported at the end of the present description.

By working on the reaction conditions, i.e., on the reaction temperature, the metal/passivating agent ratio, addition speed of the reducing aqueous solution it is possible to obtain nanoparticles comprised within the range between 1.5 and 5.2 nm as described for example by “M. J. Hostetler, J. E. Wingate, C.-J. Zhongh, J. E. Harris, R. W. Vachet, M. R. Clark, J. D. Londono, S. J. Green, J. J. Stokes, G. D. Wignall, G. L. Glish, M. D. Porter, N. D. Evans, R. W. Murray, Langmuir 1998, 14, 17-30”.

The nanoparticle ink obtained by means of one technique or the other is now used, as above mentioned, for the realization of the active film in the above ink-jet printing step 14.

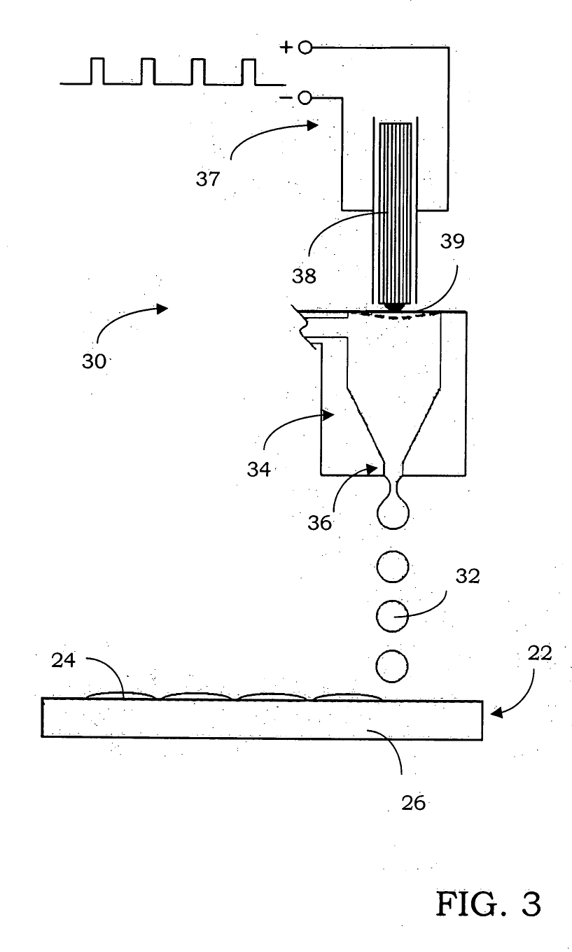

The ink-jet printing, globally indicated with number 30 in FIG. 3, is carried out according to the now consolidated technology for the ink-jet printing of liquid substances.

As it is known, the ink-jet printing is based on the expulsion of drops 32 of liquid substances, through a head 34 provided with nozzle 36, which represents the core of the tool.

In the specific case, for realizing the active film 24 any head for ink-jet printing can be used and the ink is loaded in a suitable cartridge of the printer, not shown in the drawings.

Preferably, a printer is used which works according to the “Drop on Demand Printing” (DOD) mode, which provides the emission of single drops 32 of ink.

Within this printer typology, a system 37 is preferably used for the expulsion of the ink, comprising a piezoelectric element 38, which is connected to and co-operates with the head 34 by means of a membrane 39.

The piezoelectric element 38 is subjected to electric pulses and expands and contracts according to the signal polarity. The volume variation determines a movement of the membrane 39 so as to induce the expulsion of the drop.

According to a further embodiment, the emission of the single drops is obtained by means of a heating element.

This latter is arranged inside the head for creating a steam bubble in the liquid able to induce the expulsion of the drop.

In case this technology is employed, it is necessary to ascertain that possible substances dissolved in the ink are not damaged by the heat.

In the specific case of the realization at issue an ink-jet printer of the commercial type can be used such as for example Epson (piezoelectric mechanism), or HP and Canon (thermal mechanism), or laboratory ink-jet printers such as those manufactured by Microfabi or by Microdop.

The procedure followed for the ink-jet printing according to one embodiment of the method of the present invention is that for example described in a detail in the document “Sawyer B. Fuller, Eric J. Wilhelm and Joseph M. Jacobson, Ink-jet Printed Nanoparticle Microelectrical Systems, Journal of Microelectromechanical Systems, Vol 11, N. 1, February (2002)”.

It goes without saying that, in the printing procedure, a technician of the field will resort to any precaution known in the field for optimizing the printing: for example the control of the liquid viscosity, of the nanoparticle concentration and of the interaction among the same in the solvent for avoiding the formation of self-assembled islands, the choice of the solvent, the choice of the printing head and the like.

For example, for ensuring a high quality of the self-assembled film it is suitable that the solvent evaporates in reasonable times, and as a consequence the organic solvents are preferred with respect to the aqueous ones. The evaporation of the solvent can be spontaneous or induced by means of suitable pre-heating of the substrate and possibly of the ink.

For controlling the liquid viscosity, it is sometimes convenient to use the above ink-jet head provided with heating element.

The material constituting the printing head is also important because it should ensure the absence of interaction with the ink. Preferably, in the case of the present invention, those materials having a higher chemical inertia are used, such as teflon, glass and the like.

Also the material of the substrate 26 should be as much inert as possible; to this purpose it is preferably realized with silica, with glass, with transparent polymer or similar materials.

In a preferred solution, before carrying out the printing step 14 for obtaining the active film 24, the same ink is used for realizing metallic electrodes 40 and 41 (FIG. 2), which, once they are placed in contact with the active film 24 and they are connected in a known way to a measurement apparatus 42, they allow the detection of a variation of electric conductivity.

In this case, the method 10 comprises the ink-jet printing step 18 for the realization of the electrodes 40, 41. To this purpose, the method also comprises a preliminary preparation step of a pattern for the realization of electrodes.

For maximizing the electric response of the sensor device 20 such geometries are chosen as to exalt the resistance variations during the exposition of the sensor device 20 to the chemical substances. Preferably, the method provides the use of interdigitated electrodes 40, 41 shown in FIG. 4.

According to a further embodiment, the method provides the use of two- and three-dimensional geometries by simply operating on a CAD design to be transferred to the printer.

After having introduced the ink into the cartridge, the deposition thereof follows by means of ink-jet printing according to the previously chosen pattern, and according to the previously described printing procedure.

Differently from the printing of the active film, for realizing the electrodes 40, 41 the substrate 26 is heated at a determined temperature, which, according to the material of the substrate and of the colloidal metal in solution, is comprised between 80 and 300° C.

The heating of the supporting substrate 26, besides facilitating the solvent evaporation, is used to determine a fast and controlled desorption of the passivating agent which covers the single metallic nuclei.

An aim of the thermal treatment is thus the coalescence and sintering of the metallic clusters and the obtainment of a bulk metal having micronic dimensions suitable for use as electrode.

In the realization of the electrodes, also in this case, a technician of the field will resort to any precaution necessary so that the heating temperature of the substrate ensures: thermolysis of the chemical bonds between the surface metallic atoms and the passivating agent,
separation of the passivating agent in the gaseous form,
fusion of the metallic clusters,
maintenance of the substrate morphology and quality.

The realization by means of ink-jet printing and subsequent sintering of the nanoparticles also produces some electric contacts whose conductivity is about 70% of that of the massive gold, which is much higher than that necessary for the required conductivity measure.

It is to be also noted that the morphologic analysis by means of light microscopy of the electrodes obtained by means of ink-jet printing highlights a typical wave trend, which however does not invalidate the performances of the device but only pertains the morphological aspect of the system.

According to a further embodiment of the method according to the invention, the electrodes are not realized by means of ink-jet printing, but they are already pre-assembled in the supporting substrate by means of known technologies.

In a preferred solution, according to the substrate typology and to the compatibility with the solution, the method provides a preliminary treating step of the surface of the supporting substrate and of the electrodes.

During this preliminary step, the surfaces of the supporting substrate and of the electrodes are functionalized with coupling agents of the known type, which firmly secure the active film 24 to the substrate 26 and make the sensor device 20 more resistant with respect to the aggressive action of possible disturbing agents.

After the realization of the film 24 and of the electrodes 40, 41 the method 10 also preferably comprises the exposition step 19 to expose the active film 24 to a controlled atmosphere enriched with one or more chemical substances, such as organic substances, for characterizing the electric response with respect to a known concentration of the substances.

The conductivity variations are appreciated by means of resistance measures conducted during cyclic expositions of the sensor to the analyte, so as to obtain a strict correlation of a conductivity variation with the analyte amount.

From the description disclosed up to now, it is possible to appreciate the realization of a sensor device 20, also object of the present invention, which comprises, as detection element, an active film 24 of metallic nanoparticles able to interact with the chemical substances to determine a conductivity variation of the film 24. According to the invention, the film 24 comprises a printed ink of nanoparticles.

In a preferred solution, the sensor device 20 comprises electrodes 40, 41 placed in communication with the active film 24 and comprising a printed and sintered ink of nanoparticles.

The main advantage of the method 10 is that, thanks to the ink-jet printing technique, a high simplification of the sensor assembling procedure is obtained, which allows a drastic reduction both of the number of the stages necessary for the realization of the complete device, and a simplification of the traditionally used tools.

The ink-jet printing is in fact an already consolidated technique which combines a high realization simplicity of the active film and at the same time a remarkable printing precision and reliability of the film.

It follows that the method allows a massive decrease of the manufacturing costs and times without invalidating the efficiency and the performances of the sensor device.

In particular, when the printing with “Drop on Demand Printing” mode is used a high printing resolution is obtained, as well as a high printing control.

In this way it is possible to ensure an absolute printing reproducibility of the active film which allows very reliable sensor devices to be obtained and having constant quality and performance.

This makes it also possible an industrialization of the process and the obtainment, in such a way, of wide manufacturing volumes. In particular it is possible to automate all the realizing steps of the procedure as well as to bring improvements in terms of speed and cost reduction.

It is in fact appreciated from the above description that the method according to one embodiment of the invention comprises a limited number of operative steps for the preparation of the ink and for the printing.

A further advantage is that the ink-jet printing technique can be used also for the realization of electrodes. This allows a further reduction of the costs and times, with respect to currently used technologies.

Moreover, it is to be noted that the realization of the electrodes by means of ink-jet printing allows to use the same apparatuses used for the realization of the active film, this further reducing the manufacturing times and costs.

Sensor devices realized according to the technology described in the invention show remarkable potentialities in several fields of application.

A first use in fact relates to the integration of one or more sensor devices in apparatuses for the detection of environmental pollutants.

Another interesting field of application provides the use of the sensor device as detector for instrumental analysis techniques such as gas chromatography: this use responds to the need of availing of a detector with high specificity and sensitiveness.

Still the use of this sensor device can be thought for the detection of explosive gases in highly risky areas, also called “Electronic Noses”.

Example of Metallic Nanoparticle Synthesis by Means of Polyol Process

About 2.8-8.0 g of PVP are dissolved in 20 ml of EG. The solution is left under agitation at 60°. Afterwards 5 mg of HAuCl₄ are dissolved in 1 ml of EG and they are injected into the previously prepared hot solution. During the synthesis reaction the color of the solution changes from yellow to ruby red. For completing the synthesis reaction the solution is poured into 250 ml of acetone, and everything is sonicated, for removing the excess of EG. The resulting gel, constituted by Me-PVP, is then treated with an ethanolic solution of CH₃(CH₂)₁₁SH under magnetic stirring. The replacement of capping agent leads to chemisorption of thiol molecules, for carrying out the passivation. After about 1 h the passivation reaction is completed and the metallic nanoparticles passivated with thiol are separated by centrifugation from the excess of thiol and from the PVP.

The nanoparticles are then dispersed in a suitable solvent, such as for example toluene, for obtaining the ink.

Example of Synthesis by Means of Two-Phase

30 ml of HAuCl₄ (30 mmol dm⁻³) are mixed with a solution of N(Oct)₄Br in toluene (80 ml, 50 mmol dm⁻³). The thus obtained two-phase mixture is vigorously mixed until AuCl₄⁻ is transferred into the organic phase. At this point, 170 mg of dodecanthiol (CH₃(CH₂)₁₁SH) are added to the organic phase. Afterwards, 25 ml of an aqueous sodium borohydride solution (NaBH₄) (0.4 mol dm⁻³) are slowly added under agitation to the organic phase. After a further agitation for 3 h the organic phase is separated, evaporated up to about 10 ml and mixed with ethanol for removing the excess of thiol. The mixture is maintained for 4 h at −18° C. A dark precipitate is obtained, comprising thiol-covered gold nanoparticles, which is dissolved more times in toluene and precipitated again in ethanol.

The nanoparticles are then dispersed in a suitable solvent, such as for example toluene, pentane, chloroform for obtaining the desired ink.

By operating on the reaction conditions, i.e., on the reaction temperature, on the metal/passivating agent ratio, addition speed of the reducing aqueous solution it is possible to obtain nanoparticles comprised within the range between 1.5 and 5.2 nm as from “M. J. Hostetler, J. E. Wingate, C.-J. Zhong, J. E. Harris, R. W. Vachet, M. R. Clark, J. D. Londono, S. J. Green, J. J. Stokes, G. D. Wignall, G. L. Glish, M. D. Porter, N. D. Evans, R. W. Murray, Langmuir 1998, 14, 17-30”.

All of the above U.S. patents, U.S. patent application publications, U.S. patent applications, foreign patents, foreign patent applications and non-patent publications referred to in this specification and/or listed in the Application Data Sheetare incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for realizing a sensor device suitable for detecting chemical substances and including, as detection element, an active film of metallic nanoparticles able to interact with the chemical substances for determining a variation of the overall electric conductivity of the film, the method comprising the steps of:
preparing an ink comprising a solution of metallic nanoparticles; and
ink-jet printing the ink on a supporting substrate so as to form said active film.

2. The method according to claim 1, wherein the inkjet printing is carried out by ejecting single drops of ink through a printing head provided with a nozzle.

3. The method according to claim 2, wherein ejecting the single drops is carried out by interacting the ink with a piezoelectric element connected with said head.

4. The method according to claim 2, wherein ejecting the single drops is carried out by interacting the ink with a heating element connected with the head.

5. The method according to claim 1, further comprising ink-jet printing ink to form metallic electrodes which are placed in contact with the active film and which are connected with a testing device to detect a variation of electric conductivity.

6. The method according to claim 5, wherein the electrodes are realized with the same ink obtained for realizing the active film.

7. The method according to claim 5, wherein the ink used to form the metallic electrodes includes metallic nuclei passivated with passivating agents and ink-jet printing ink to form the metallic electrodes includes heating the substrate to evaporate the passivating agents and sinter the metallic nuclei.

8. The method according to claim 7, wherein the heating step includes maintaining the substrate at a temperature comprised between 80 and 300° C.

9. The method according to claim 5, further comprising preparing a pattern for realizing the electrodes by using a CAD software.

10. The method according to claim 5, further comprising interdigitating the electrodes.

11. The method according to claim 6, further comprising preliminarily treating the electrodes and a surface of the supporting substrate by functionalization with coupling agents.

12. The method according to claim 1, wherein the preparing step comprises synthesizing metallic nuclei, passivating the synthesized metallic nuclei to obtain the nanoparticles, and dissolving the nanoparticles in solvent to obtain the ink.

13. The method according to claim 12, wherein the synthesizing step comprises an oxidation-reduction reaction between a metallic precursor and a polyolic reducing agent.

14. The method according to claim 13, wherein the oxidation-reduction reaction is carried out in the presence of a capping agent, for controlling the morphology and dimensions of the metallic nanoparticles.

15. The method according to claim 14, wherein the capping agent is a polyvinylpyrolidone.

16. The method according to claim 13, wherein the synthesizing is carried out by a reduction of trihydrated chloride of Au(III) with ethylene glycol in the presence of polyvinylpyrrolidone.

17. The method according to claim 13, wherein the metallic nuclei are passivated by a thiol or an amine.

18. The method according to claim 13, wherein the dissolving step includes dissolving the nanoparticles in an organic solvent of a group consisting of toluene, chloroform, hexane, and superior homologs thereof.

19. The method according to claim 13, wherein the synthesizing step comprises an oxidation-reduction reaction of a metallic precursor in an environment in a two-phase system, and the passivating step is carried out in the environment of the oxidation-reduction reaction.

20. The method according to claim 19, wherein the synthesizing and passivating steps are performed by reducing HAuCl₄ in an emulsion of H₂O, toluene, and passivating agent in the presence of tetraoctilammonium bromide as phase transfer agent and of aqueous sodium borohydride as reducing agent.

21. The method according to claim 1, wherein the ink comprises a colloidal solution of gold nanoparticles in toluene.

22. The method according to claim 1, further comprising exposing the active film to a controlled atmosphere enriched with one or more chemical substances for characterizing the electric response with respect to a known substance concentration.

23. A sensor device for monitoring the presence of chemical substances, comprising:
a supporting substrate; and
an active film of metallic nanoparticles, arranged on the supporting substrate and structured to act as a detection element by interacting with the chemical substances to determine a conductivity variation of the active film, wherein the active film comprises a printed ink of nanoparticles.

24. The sensor device according to claim 23, wherein the printed ink comprises metallic nanoparticles having mean dimensions within a range from 1.5 to 20 nm.

25. The sensor device according to claim 23, wherein the printed ink comprises metallic nanoparticles comprising a metallic nucleus and a protection shell comprising a passivating agent.

26. The sensor device according to claim 23, further comprising electrodes placed in communication with the active film and comprising a printed and sintered ink of nanoparticles.

27. The sensor device according to claim 26, wherein said electrodes are interdigitated.

28. The sensor device according to claim 26, wherein said electrodes and said active film comprise the same printed ink of nanoparticles.

29. A method for realizing a sensor device, the method comprising:
preparing an ink comprising a solution of passivated metallic nanoparticles; and
inkjet printing the ink on a supporting substrate, the passivated metallic nanoparticles of the ink forming sensor elements that are sensitive to one or more chemical substances.

30. The method of claim 29 wherein the ink-jet printing includes forming an active film of the passivated metallic nanoparticles.

31. The method of claim 29, further comprising ink-jet printing ink to form conductive electrodes on the substrate, the electrodes being structured for coupling with a testing device to detect a variation of electric conductivity of the passivated metallic nanoparticles.

32. The method of claim 31, wherein the electrodes are realized with the same ink obtained for realizing the sensor elements.

33. The method of claim 31, wherein the ink used to form the metallic electrodes includes metallic nuclei passivated with passivating agents and ink-jet printing ink to form the metallic electrodes includes heating the substrate to evaporate the passivating agents and sinter the metallic nuclei.

34. The method of claim 33, wherein the heating step includes maintaining the substrate at a temperature comprised between 80 and 300° C.

35. The method of claim 31, further comprising preparing a pattern for realizing the electrodes by using CAD software, wherein the step of ink-jet printing ink to form the metallic electrodes includes ink-jet printing the ink according to the prepared pattern.

36. The method of claim 29, further comprising exposing the passivated metallic nanoparticles to a controlled atmosphere enriched with one or more chemical substances for characterizing an electric response with respect to a known substance concentration.
